(19) United States
(12) Patent Application Publication
(10) Pub. No.: US 2011/0265686 A1
(43) Pub. Date: Nov. 3, 2011

(54) INK COMPOSITION FOR INK JET RECORDING

(75) Inventors: Shuichi Koganehira, Matsumoto-shi (JP); Masahiro Yatake, Shiojiri-shi (JP)

(73) Assignee: Seiko Epson Corporation, Tokyo (JP)

(21) Appl. No.: 13/096,270

(22) Filed: Apr. 28, 2011

(30) Foreign Application Priority Data
Apr. 28, 2010 (JP) 2010-104046

(51) Int. Cl. C09D 11/02

(52) U.S. Cl. 106/31.13

(57) ABSTRACT

An ink composition for ink jet recording is provided. The ink composition includes at least a colorant, water, a poor water-soluble both-end-type alkanediol, a crystalline sugar alcohol that is solid at 20° C., and a poly(alkylene glycol). The poor water-soluble both-end-type alkanediol includes one or two alkyl substituents on its main chain having two hydroxyl groups.

Priority is claimed under 35 U.S.C §119 to Japanese Application No. 2010-104046 filed on Apr. 28, 2010, which is hereby incorporated by reference in its entirety.

### BACKGROUND

1. Technical Field

The present invention relates to an ink composition for ink jet recording that can provide a recorded matter with high quality and high color development on various recording media, especially, even on recording media having a low ink-absorbing property, such as fine coated paper and printing paper.

2. Related Art

An ink jet recording method is a printing process for conducting printing by letting ink droplets fly and adhere to a recording medium such as paper. According to recent innovative progress in ink jet recording technology, the ink jet recording method has become to be also used in the field of highly fine printing that has been achieved by silver halide photography or offset printing before. With the development of the ink jet recording method, inks for ink jet recording have been developed so that an image having gloss similar to that of silver halide photography can be formed by the ink jet recording on a recording medium, so-called exclusive paper, having high gloss comparable to that of photographic paper or art paper used in the fields of silver halide photography and offset printing. Furthermore, inks for ink jet recording that can realize image quality comparable to that of silver halide photography even when plain paper is used have been developed.

Incidentally, desk top publishing (DTP) has been spreading in recent years, in particular, in the printing field, in accordance with wide spreading of a technology for forming an image from digital data. Even when printing is performed by DTP, a color proof is produced in advance for comparing the gloss and color impression with those of an actual printed matter. The ink jet recording system is applied to output of the proof, and exclusive paper for ink jet recording is usually used as the recording medium because of requirements for high color reproducibility and high color stability of the printed matter in DTP.

A proof sheet, which is exclusive paper for ink jet recording, is produced so as to provide gloss and color impression similar to those of actual output printed on printing paper. Thus, the material for the exclusive paper is appropriately adjusted according to the type of printing paper. On the other hand, production of exclusive paper that can cope with all of various types of printing paper causes an increase in manufacturing cost. Accordingly, in the use for color proof, there is a demand for conducting ink jet recording on printing paper rather than on exclusive paper, from a technical viewpoint. Furthermore, if it is possible to use a recorded matter produced directly on printing paper, not on exclusive paper, by ink jet recording as a final proof sample, the cost for proof can be significantly decreased, and, therefore, such use is demanded from an economical viewpoint. In addition, fine coated paper, which is widely used in the printing field, has recently attracted attention as a material that is excellent in recyclability and environment-friendly. There is a demand for conducting recording on such fine coated paper from the environmental viewpoint.

The printing paper is coated paper having a surface provided with a coating layer for receiving oil-based ink and thereby has a characteristic of being poor in aqueous-ink-absorbing ability caused by the coating layer. Therefore, if an aqueous pigment ink, which is usually used in ink jet recording, is used, bleeding or aggregation spots may occur in an image because of low permeability of the ink into the recording medium (printing paper).

For the above-mentioned problems, for example, JP-A-2005-194500 discloses a pigment ink that is improved in bleeding and is excellent in gloss on exclusive paper by using a polysiloxane compound as a surfactant and including an alkanediol, such as 1,2-hexanediol, as a solubilization aid. In addition, JP-A-2003-213179, JP-A-2003-253167, and JP-A-2006-249429 propose methods to obtain high-quality images by controlling permeability of ink into recording media by adding a diol solvent, such as glycerin or 1,3-butanediol, or a triol solvent, such as pentanetriol, to the ink.

However, there is still a demand for development of an ink composition that can realize an image having high quality and high color development and being free from bleeding and beading and that is excellent in a recovery property from clogging even after being left under an open environment at high temperature and low humidity or under a close environment at high temperature and ordinary humidity and is also excellent in inhibition of curling.

### SUMMARY

The inventors have recently found the fact that when an ink composition for ink jet recording contains a poor water-soluble both-end-type alkanediol, a crystalline sugar alcohol that is solid at 20° C. (hereinafter, may be simply referred to as “crystalline sugar alcohol”), and a poly(alkylene glycol), an image having high quality and high color development and being free from bleeding and beading can achieved, for example, even when printing is performed on a recording medium having a low aqueous ink-absorbing property, such as printing paper, and the ink composition is excellent in a recovery property from clogging even after being left under an open environment at high temperature and low humidity or under a close environment at high temperature and ordinary humidity and is also excellent in inhibition of curling. The invention is based on this finding.

Accordingly, in advantage of some aspects of the invention is to provide an ink composition for ink jet recording that can form an image having high quality and high color development and being free from bleeding and beading, for example, even when printing is performed on a recording medium having a low aqueous ink-absorbing property, such as fine coated paper or printing paper, and that is excellent in a recovery property from clogging even after being left under an open environment at high temperature and low humidity or under a close environment at high temperature and ordinary humidity and is excellent in inhibition of curling.

The ink composition for ink jet recording according to an aspect of the invention contains at least a colorant, water, a poor water-soluble both-end-type alkanediol, a crystalline sugar alcohol that is solid at 20° C., and a poly(alkylene glycol).

According to the ink composition for ink jet recording according to an aspect of the invention, it can be provided an ink composition that can form an image having high quality and high color development and being free from bleeding and beading, for example, even when printing is performed on a recording medium having a low aqueous ink-absorbing property, such as fine coated paper or printing paper, and that is excellent in a recovery property from clogging even after being left under an open environment at high temperature and low humidity or under a close environment at high temperature and ordinary humidity and is excellent in inhibition of curling.

### DESCRIPTION OF EXEMPLARY EMBODIMENTS

### Definition

In the specification, the hydrocarbon group portion of an alkanediol may be either a linear chain or a branched chain.

The term “water-soluble” refers to that the solubility in water (the amount of a solute in 100 g of water) at 20° C. is 10.0 g or more, and the term “poor water-soluble” refers to that the solubility in water (the amount of a solute in 100 g of water) is less than 1.0 g. The term “miscible” refers to that a solution is translucent when the solubility in water (the amount of a solute in 100 g of water) at 20° C. is 10.0 g.

### Ink Composition

The ink composition according to an aspect of the invention contains at least a poor water-soluble both-end-type alkanediol, a specific crystalline sugar alcohol, and a poly(alkylene glycol). By containing these organic solvents and other components in combination, provided is an ink composition that is inhibited from beading of the ink composition, for example, on fine coated paper or printing paper, that can form a high-quality and high-gloss image being free from bleeding and beading and, in particular, even when printing with a short difference in ink landing time is performed, that is excellent in a recovery property from clogging even after being left under an open environment at high temperature and low humidity or under a close environment at high temperature and ordinary humidity, and that is excellent in inhibition of curling and in discharge stability.

In the specification, the term “beading” refers to local density spots with similar colors occurring in monochromatic printing (for example, when a 6-inch square monochromatic image (which means that a single color is obtained as a result of the printing, and a plurality of ink compositions may be used for forming the color) is printed) and does not refer to that a region not covered with the ink remains on a recording medium surface. Furthermore, the term “bleeding of a color material” refers to a phenomenon in that a mixed color occurs near the boundary between adjoining monochromatic areas (for example, when 3-inch square monochromatic areas having the respective colors are printed so as to adjoin to one another). The term “bleeding of a solvent” refers to a phenomenon in that density spots with similar colors occur near the boundary between adjoining monochromatic areas (for example, when 3-inch square monochromatic areas having the respective colors are printed so as to adjoin to one another) by a change in the coating state, which is caused by migration of the color material or the like by leaching of the solvent.

In an aspect of the invention, when thin fine coated paper having a paper weight of 73.3 to 104.7 g/m² or 104.7 to 209.2 g/m² is used, furthermore, even when thin fine coated paper having a paper weight of 73.3 to 104.7 g/m² is used as the above-described recording medium, the printed face is inhibited from rolling inward, that is, so-called curling is inhibited from occurring.

It is not clear why a high-quality image being free from bleeding and beading can be formed by an ink composition containing a poor water-soluble both-end-type alkanediol, in addition to a poly(alkylene glycol) and a crystalline sugar alcohol that is solid at 20° C., as described above, but it is assumed as follows.

The beading of an ink, which occurs in recording, for example, on fine coated paper is thought to be caused by that the fine coated paper repels the ink because of the high surface tensions of ink droplets and large contact angles of the ink droplets with the fine coated paper surface. The repelled ink droplets flow together with adjacent ink droplets to aggregate with one another, resulting in beading. Therefore, it is believed that, in order to inhibit beading of ink, it is preferable to inhibit flowage spots of ink droplets by reducing the surface tension of the ink droplets.

The bleeding of ink, which occurs in recording, for example, on fine coated paper is thought to be caused by that since ink droplets have different surface tensions, ink droplets having low surface tensions adhered to the surface of the fine coated paper saturate ink droplets having high surface tensions and spread thereto, resulting in a flow of the ink. This ink flow is thought to be also affected by the difference of adhesion times of adjacent ink droplets and the sizes of droplets at the time of adhering.

Therefore, it is believed that, in order to inhibit bleeding of ink, it is preferable to adjust the surface tensions of ink compositions to be equal. However, it is difficult that the intervals of adhesion times of adjacent ink droplets or the sizes of droplets at the time of adhering are also adjusted to be equal, and it is therefore believed that it is preferable to reduce flowage spots of ink droplets.

It is believed that, in the ink composition according to an aspect of the invention, ink having a low surface tension and low fluidity can be achieved without impairing other qualities required in an ink composition and that, as a result, bleeding and beading are effectively inhibited.

### Poor Water-Soluble Both-End-Type Alkanediol

The ink composition according to an aspect of the invention contains a poor water-soluble both-end-type alkanediol.

According to a preferred aspect of the invention, the poor water-soluble both-end-type alkanediol is preferably an alkanediol having 7 or more carbon atoms, more preferably a both-end-type alkanediol including one or two substituents on its main chain having two hydroxyl groups. In the both-end-type alkanediol including one or two substituents on its main chain having two hydroxyl groups, the substituents are each preferably an alkyl group, more preferably an alkyl group having 1 to 4 carbon atoms. The two substituents may be the same alkyl groups or different alkyl groups. The main chain having two hydroxyl groups in the alkanediol preferably has a carbon length of 3 to 8 carbon atoms, more preferably of 3 carbon atoms. Preferred specific examples of the alkanediol include 2-methyl-2-propyl-1,3-propanediol, 2-butyl-2-ethyl-1,3-propanediol, 2-butyl-2-methyl-1,3-propanediol, 2,2-dibutyl-1,3-propanediol, and 2,2-diisobutyl-1,3-propanediol. Among them, from the viewpoint of harmfulness, those having butyl in the side chain, that is, 2-butyl-2-methyl-1,3-propanediol, 2-butyl-2-ethyl-1,3-propanediol, 2,2-dibutyl-1,3-propanediol, and 2,2-diisobutyl-1,3-propanediol are preferred, and 2-butyl-2-methyl-1,3-propanediol and 2-butyl-2-ethyl-1,3-propanediol are particularly preferred.

According to a preferred aspect of the invention, the content of the poor water-soluble both-end-type alkanediol may be appropriately determined in a range that can efficiently inhibit bleeding and beading of the ink, but is preferably 1.0 to 4.0% by mass, more preferably 1.5 to 3.0% by mass, and most preferably 2.0 to 2.5% by mass based on the total amount of the composition. An amount of the poor water-soluble both-end-type alkanediol within the above-mentioned range, especially, an amount not less than the lower limit, can sufficiently inhibit occurrence of beading. In addition, an amount of the poor water-soluble both-end-type alkanediol within the above-mentioned range, especially, an amount not higher than the upper limit, can prevent the initial viscosity of the ink from becoming too high and can effectively avoid separation of an oil phase under usual ink storage conditions, and is therefore preferred from the viewpoint of ink storage stability.

Poly(alkylene glycol)

The ink composition according to an aspect of the invention contains a poly(alkylene glycol).

The poly(alkylene glycol) contained in the ink composition according to an aspect of the invention is preferably represented by a formula: HO—[(CH₂)ₙ—O)]ₘ—H (in the formula, n denotes 2 or 3, and m denotes an integer of 1 to 3), and is more preferably one or more selected from the group consisting of ethylene glycol, diethylene glycol, triethylene glycol, propylene glycol, dipropylene glycol, and tripropylene glycol. These compounds are oligomers obtained by addition polymerization of ethylene oxide and/or propylene oxide. According to a preferred aspect of the invention, the poly(alkylene glycol) is more preferably a poly(propylene glycol) and most preferably a water-miscible poly(propylene glycol). The poly(propylene glycol) is not particularly limited, but is preferably a diol-type from the viewpoints of ecotoxicity and environmental toxicity, and is more preferably tripropylene glycol (CAS No. 24800-44-0) from the viewpoint of its low moisture absorbency. Most preferably, the diol-type poly(propylene glycol) and the tripropylene glycol are water-miscible.

In an aspect of the invention, the amount of the poly(alkylene glycol) may be appropriately determined in a range that can efficiently inhibit bleeding and beading of the ink, but is preferably 2.0 to 10.0% by mass and more preferably 4 to 8% by mass based on the total amount of the ink composition. An amount of the poly(alkylene glycol) within the above-mentioned range, especially, an amount not lower than the lower limit, can maintain the poor water-soluble both-end-type alkanediol in a mixed state without causing separation in the drying process of ink droplets and is therefore preferred. An amount of the poly(alkylene glycol) within the above-mentioned range, especially, an amount not higher than the upper limit, can prevent the initial viscosity of the ink from becoming too high and can effectively avoid separation of an oil phase under usual ink storage conditions and is therefore preferred from the viewpoint of ink storage stability, and also such an amount can prevent occurrence of an incompatible state and is therefore preferred from the viewpoint of gloss.

In addition, the poly(alkylene glycol) contained in the ink composition according to an aspect of the invention is hardly dried even if it is left under high temperature and low humidity and can also advantageously improve the recovery property from clogging of a nozzle under an open environment of 50° C./15% humidity.

Furthermore, it has been found that the ink composition according to an aspect of the invention in which a pigment is dispersed in a dispersion resin shows an effect of inhibiting the ink from too rapidly aggregating on a recording medium. The reason thereof is not clear, but it is assumed as follows.

It is thought that, in general, at the moment when ink adheres to a recording medium, the lipophilic components in the ink are still being dispersed in water, but phase transition from an O/W state to a W/O state is caused by that the water is lost first during the drying process after the adhesion of the ink to the recording medium. The aqueous phase of the ink includes a pigment dispersed in a water-dispersible resin, but the pigment cannot be present in the oil phase. Therefore, it is thought that the fluidity of the pigment in the aqueous phase is inhibited by the wall of the oil phase when the O/W state is phase-transited to the W/O state, which causes flowage spots, resulting in aggregation of the ink. However, it is thought that since the poly(alkylene glycol) allows water and a poor water-soluble solvent to mutually dissolve in each other and can maintain the mixed state for a long time, formation of the wall of the oil phase is prevented. It is thought that, as a result, the pigment can be held in the mixed phase to prevent flowage spots from being formed, resulting in inhibition of formation of infiltration spots of the ink.

The content ratio of the poor water-soluble both-end-type alkanediol to the poly(alkylene glycol) is preferably 1:1 to 1:5 and more preferably 1:2 to 1:4. In this range, the discharge stability of ink can be improved.

### Crystalline Sugar Alcohol

The ink composition according to an aspect of the invention contains a crystalline sugar alcohol that is solid at 20° C.

The crystalline sugar alcohol is not particularly limited as long as it can achieve the effects of the invention, but is preferably one or more selected from the group consisting of maltose, maltitol, sorbitol, xylitol, erythritol, trehalose, isotrehalose, neotrehalose, sucrose, and sucralose, and more preferably one or more selected from glycosidically bonded nonreducing disaccharides and glycosides. Particularly preferred is one or more selected from the group consisting of trehalose, isotrehalose, neotrehalose, and sucrose.

Furthermore, the crystalline sugar alcohol may be a tri- or higher saccharide in which one or more of monosaccharides and disaccharides selected from the group consisting of maltose, maltitol, sorbitol, xylitol, erythritol, trehalose, isotrehalose, neotrehalose, sucrose, and sucralose are glycosidically bonded to each other or to another saccharide.

Trehalose is a nonreducing disaccharide in which 1-positions of two glucose molecules are linked to each other by a glucoside bond. Since trehalose is a nonreducing saccharide, brown discoloration by a Maillard reaction does not occur. Therefore, trehalose is preferred from the viewpoint of ink storage stability. In addition, since the crystallinity of trehalose is high, it has characteristics that water solubility is low and that moisture absorbency is significantly low.

Isotrehalose, neotrehalose, and sucrose are nonreducing disaccharides in which glycoside bonds are formed. Since they are nonreducing disaccharides, brown discoloration by a Maillard reaction does not occur. Therefore, they are preferred from the viewpoint of ink storage stability. In addition, since their crystallinity is high, they have characteristics that water solubility is low and that moisture absorbency is significantly low.

The ink composition containing such a crystalline sugar alcohol can inhibit beading, which is caused by flowage spots that occur, in particular, when printing with a short difference in ink landing time is performed. The reason thereof is not clear, but it is assumed that since the crystalline sugar alcohol is not dissolved in a solvent and has low water solubility and high crystallinity, solidification occurs immediately after ink landing to reduce fluidity of the ink, which inhibits formation of flowage spots and thereby inhibits occurrence of beading. In addition, it is assumed that since the fluidity is immediately inhibited, ink droplets coming into contact with already landed ink droplets are hardly affected by the already landed ink droplets to inhibit formation of flowage spots, resulting in inhibition of occurrence of beading even in multicolor printing. Furthermore, it is assumed that the osmotic pressure is increased by the large amount of the water-soluble sugar, according to van't Hoff's law, to increase the permeation rate.

The ink composition containing such a crystalline sugar alcohol can have an improved recovery property from clogging under a close environment at high temperature and ordinary humidity. The reason thereof is not clear, but it is assumed that since the crystalline sugar alcohol has significantly low moisture absorbency, waste ink remaining in a cap does not seize moisture from the meniscus ink in a nozzle, resulting in an excellent recovery property from clogging in the state in which the cap is sealed.

Furthermore, since the ink composition containing such a crystalline sugar alcohol prevents ice crystals from growing, low-temperature storage stability of the ink can be improved.

According to a preferred aspect of the invention, the amount of the crystalline sugar alcohol may be appropriately determined in a range that the above-described effects can be achieved, but is preferably 2.0 to 10.0% by mass and more preferably 4.0 to 8.0% by mass based on the total amount of the ink composition. An amount of the crystalline sugar alcohol within the above-mentioned range, especially, an amount not lower than the lower limit, improves the recovery property from clogging under a close environment at high temperature and ordinary humidity and is therefore preferred, and such an amount is also preferred from the viewpoint of gloss. An amount of the crystalline sugar alcohol within the above-mentioned range, especially, an amount not higher than the upper limit, prevents the initial viscosity of the ink from becoming too high and decreases the freezing temperature of the ink and is therefore preferred from the viewpoint of low-temperature storage stability of the ink.

Furthermore, according to a preferred aspect of the invention, the content ratio of the poor water-soluble both-end-type alkanediol to the crystalline sugar alcohol is preferably 1:1 to 1:5 and more preferably 1:2 to 1:4. Within this range, beading when ink droplet landing intervals are short can be inhibited.

The ratio of the sum of contents of the poly(alkylene glycol) and the crystalline sugar alcohol to the content of the poor water-soluble both-end-type alkanediol is preferably 2:1 to 20:1. Within this range, recovery properties from clogging under an open environment at high temperature and low humidity and under a close environment at high temperature and ordinary humidity can be ensured. The reason thereof is not clear, but it is assumed to be due to a good balance between the effect of the poly(alkylene glycol) for redissolving solidified ink near a nozzle and the effect of the crystalline sugar alcohol for blocking absorption of moisture.

A recorded matter having excellent gloss can be obtained without causing beading, even when ink droplet landing intervals are short, by adjusting the content ratio within the above-mentioned range. The reason thereof is not clear, but it is assumed to be due to a good balance between the effect of mixing and dissolving the poor water-soluble both-end-type alkanediol by means of the poly(alkylene glycol) and the effect of inhibiting flowage spots by increasing the amount of solid of the crystalline sugar alcohol.

Furthermore, according to a preferred aspect of the invention, the sum of the content of the poor water-soluble both-end-type alkanediol and the content of the poly(alkylene glycol) or the crystalline sugar alcohol is preferably 24.0% by mass or less based on the amount of the ink composition. In this range, the initial viscosity of the ink can be lowered, beading on a recording medium having low ink absorbability, such as fine coated paper or printing paper, does not occur, and also bleeding of color materials is inhibited.

Furthermore, according to a preferred aspect of the invention, the sum of the contents of the poor water-soluble both-end-type alkanediol, the poly(alkylene glycol), and the crystalline sugar alcohol is preferably 44% by mass or less based on the amount of the ink composition. In this range, the initial viscosity of the ink can be lowered, and the recovery properties from clogging under an open environment at high temperature and low humidity and under a close environment at high temperature and ordinary humidity can be appropriately adjusted without causing occurrence of beading spots on a recording medium having low ink absorbability, such as fine coated paper or printing paper.

### Water-Soluble Alkanediol

According to a preferred aspect of the invention, the ink composition according to an aspect of the invention may further contain a water-soluble alkanediol, in addition to the poor water-soluble both-end-type alkanediol, the crystalline sugar alcohol, and the poly(alkylene glycol). This can advantageously further inhibit occurrence of bleeding of materials other than the solids contained in the ink composition, that is, the aqueous solution including the solvent.

According to a preferred aspect of the invention, the water-soluble alkanediol is preferably a both-end-type or one-end-type alkanediol. Furthermore, the water-soluble alkanediol according to an aspect of the invention is preferably an alkanediol having 3 or more carbon atoms and more preferably an alkanediol having 3 to 6 carbon atoms. Preferred examples of the water-soluble alkanediol contained in the ink composition according to an aspect of the invention include water-soluble hexanediols such as 1,2-hexanediol and 1,6-hexanediol, and 3-methyl-1,5-pentanediol. Among them, 1,2-hexanediol and 3-methyl-1,5-pentanediol are preferred. In particular, 1,2-hexanediol is a preferred from the viewpoint of discharge stability at high frequency.

Furthermore, according to a preferred aspect of the invention, the content ratio of the poor water-soluble both-end-type alkanediol to the water-soluble alkanediol is preferably 1:1 to 10:1 and more preferably 2:1 to 4:1. In this range, beading when ink droplet landing intervals are short can be inhibited.

According to a preferred aspect of the invention, the sum of the content of the water-soluble alkanediol and the content of the poly(alkylene glycol) or the crystalline sugar alcohol is preferably 24% by mass or less and more preferably 12% by mass or less based on the amount of the ink composition. In this range, beading when ink droplet landing intervals are short can be inhibited.

Furthermore, according to a preferred aspect of the invention, the sum of the content of the poly(alkylene glycol) or the crystalline sugar alcohol, the content of the water-soluble alkanediol, and the content of the poor water-soluble both-end-type alkanediols is preferably 28% by mass or less, more preferably 14% by mass or less, based on the amount of the ink composition. In this range, bleeding when ink droplet landing intervals are short can be inhibited.

According to a preferred aspect of the invention, the amount of the water-soluble alkanediol may be appropriately determined as long as it can efficiently inhibit bleeding and beading of the ink, but is preferably 0.1 to 4.0% by mass, more preferably 0.5 to 3.0% by mass, and most preferably 1.0 to 2.0% by mass based on the total amount of the ink composition. An amount of the water-soluble alkanediol in the above-mentioned range, especially, an amount not lower than the lower limit, can sufficiently inhibit occurrence of bleeding. An amount of the water-soluble alkanediol in the above-mentioned range, especially, an amount not higher than the upper limit, can prevent the initial viscosity of the ink from becoming too high and can effectively avoid separation of an oil phase under usual ink storage conditions, and is therefore preferred from the viewpoint of ink storage stability. When one or more selected from the group consisting of 1,2-hexanediol, 1,6-hexanediol, and 3-methyl-1,5-pentanediol are contained as a preferred example of the water-soluble alkanediol in an amount of 0.1 to 4% by mass based on the total amount of the ink composition, a high-quality image being free from bleeding and beading can be formed. Thus, the water-soluble alkanediol is effective as an adjuster when a discharging ability varies depending on the type of the pigment and the amount of the resin.

### Other Solvent

According to a preferred aspect of the invention, the ink composition may further contain triethylene glycol monomethyl ether. By containing 0.1 to 4% by mass of triethylene glycol monomethyl ether, the recovery property from clogging in the ink cap for capping an ink jet head can be improved. Here, the term “clogging in the ink cap” refers to that liquid waste remaining in the cap is solidified by drying and clogs the micropores of an ink absorber, such as nonwoven fabric, in the ink cap. By improving the recovery property from clogging in the ink cap, a reduction in success rate of cleaning can be prevented, and the recovery property from nozzle clogging can be improved.

### Colorant

The colorant used in the ink composition for ink jet recording according to an aspect of the invention may be a dye or a pigment, but the pigment is preferred from the viewpoints of light resistance and water resistance. Furthermore, the colorant preferably contains the pigment and a dispersant that can disperse the pigment in ink.

Examples of the pigment include inorganic pigments and organic pigments, and these may be used alone or as a mixture of two or more thereof. Examples of the inorganic pigment that can be used include carbon black produced by a known method such as a contact method, a furnace method, or a thermal method as well as titanium oxide and iron oxide. Examples of the organic pigment include azo pigments (including, for example, azolakes, insoluble azo pigments, condensed azo pigments, and chelate azo pigments), polycyclic pigments (for example, phthalocyanine pigments, perylene pigments, perynone pigments, anthraquinone pigments, quinacridone pigments, dioxadine pigments, thioindigo pigments, isoindolinone pigments, and quinophthalone pigments), dye chelates (for example, basic dye-type chelates and acid dye-type chelates), nitro pigments, nitroso pigments, and aniline black.

Specific examples of the pigment can be exemplified according to the type (color) of ink composition to be prepared. Examples of the pigment for a yellow ink composition include C.I. pigment yellows 1, 2, 3, 12, 14, 16, 17, 73, 74, 75, 83, 93, 95, 97, 98, 109, 110, 114, 128, 129, 138, 139, 147, 150, 151, 154, 155, 180, and 185, and one or more thereof are used. In particular, one or more selected from the group consisting of C.I. pigment yellows 74, 110, 128, and 129 are preferably used. Examples of the pigment for a magenta ink composition include C.I. pigment reds 5, 7, 12, 48(Ca), 48(Mn), 57(Ca), 57:1, 112, 122, 123, 168, 184, 202, and 209 and C.I. pigment violet 19, and one or more thereof are used. In particular, one or more selected from the group consisting of C.I. pigment reds 122, 202, and 209 and C.I. pigment violet 19 are preferably used, and also a solid solution thereof may be used. Examples of the pigment for a cyan ink composition include C.I. pigment blues 1, 2, 3, 15:3, 15:4, 15:34, 16, 22, and 60 and C.I. vat blues 4 and 60, and one or more thereof are used. In particular, C.I. pigment blue 15:3 and/or 15:4 are preferably used. Especially, C.I. pigment blue 15:3 is preferably used.

Examples of the pigment for a black ink composition include inorganic pigments, for example, carbons, such as lamp black (C.I. pigment black 6), acetylene black, furnace black (C.I. pigment black 7), channel black (C.I. pigment black 7), and carbon black (C.I. pigment black 7), and iron oxide pigments; and organic pigments, such as aniline black (C.I. pigment black 1). In an aspect of the invention, carbon black is preferably used. Specific examples of the carbon black include #2650, #2600, #2300, #2200, #1000, #980, #970, #966, #960, #950, #900, #850, MCF-88, #55, #52, #47, #45, #45L, #44, #33, #32, and #30 (these are products of Mitsubishi Chemical Corp.), Special Blaek 4A and 550 and Printex 95, 90, 85, 80, 75, 45, and 40 (these are products of Degussa AG), Regal 660, Rmogul L, and monarch 1400, 1300, 1100, 800, and 900 (these are products of Cabot Corp.), and Raven 7000, 5750, 5250, 3500, 2500 ULTRA, 2000, 1500, 1255, 1200, 1190 ULTRA, 1170, 1100 ULTRA, and Raven 5000 UIII (these are products of Columbian Chemicals Co.).

The concentration of the pigment is not particularly limited and may be adjusted to an appropriate concentration (content) at the time when the ink composition is prepared. However, in an aspect of the invention, the concentration of the solid of the pigment is preferably 7% by mass or more and more preferably 10% by mass or more. Ink droplets wet and spread on the surface of a recording medium when they adhere onto the recording medium. Since the fluidity of the ink is rapidly lost after stoppage of the saturation and spreading by adjusting the solid concentration of the pigment to a high level of 7% by mass or more, bleeding can be further inhibited even when low-resolution printing is performed on a recording medium, such as fine coated paper or printing paper. That is, it is assumed that the use of a combination of the poor water-soluble both-end-type alkanediol, the crystalline sugar alcohol, and the poly(alkylene glycol) allows the ink to wet and spread even on a recording medium having low ink absorbability, the effect of the crystalline sugar alcohol allows an increase in the solid content without significantly increasing the initial viscosity to accelerate the drying rate, and the increased solid content because of the pigment in the ink allows a decrease in the fluidity of the ink on a recording medium to inhibit bleeding. In particular, the effects of inhibiting beading and bleeding are significant when the recording time interval between the landing of an ink droplet and the landing of the subsequent ink droplet so as to be adjacent or overlap the previous ink droplet is about 0.1 second or more and shorter than 2 seconds. The term “recording time interval” refers to the interval of time between applications of a plurality of different inks onto a recording medium so as to be adjacent or overlap to each other or the interval of time between two sequential recordings when the recordings are separated into the recording pixel number.

The above-mentioned pigment is preferably kneaded with a dispersant described below, from the viewpoints of achieving good balance among gloss of an image, prevention of bronzing, and storage stability of the ink composition and also of forming the color image with more excellent gloss.

### Dispersant

The ink composition according to an aspect of the invention preferably contains, as a dispersant for dispersing the colorant, at least one resin selected from the group consisting of styrene-acrylic acid-based copolymer resins, oxyethyl acrylate-based resins, urethane-based resins, and fluorene-based resins, and more preferably at least one selected from the group consisting of oxyethyl acrylate-based resins and fluorene-based resins. These copolymer resins adsorb to pigments to improve the dispersibility of the pigments.

Specific examples of the hydrophobic monomer of the copolymer resin include methyl acrylate, methyl methacrylate, ethyl acrylate, ethyl methacrylate, n-propyl acrylate, n-propyl methacrylate, iso-propyl acrylate, iso-propyl methacrylate, n-butyl acrylate, n-butyl methacrylate, sec-butyl acrylate, sec-butyl methacrylate, tert-butyl acrylate, tert-butyl methacrylate, n-hexyl acrylate, n-hexyl methacrylate, n-octyl acrylate, n-octyl methacrylate, iso-octyl acrylate, iso-octyl methacrylate, 2-ethyl hexyl acrylate, 2-ethyl hexyl methacrylate, decyl acrylate, decyl methacrylate, lauryl acrylate, lauryl methacrylate, stearyl acrylate, stearyl methacrylate, 2-hydroxyethyl acrylate, 2-hydroxyethyl methacrylate, 2-hydroxypropyl acrylate, 2-hydroxypropyl methacrylate, 2-dimethylaminoethyl acrylate, 2-dimethylaminoethyl methacrylate, 2-diethylaminoethyl acrylate, 2-diethylaminoethyl methacrylate, glycidyl acrylate, glycidyl methacrylate, allyl acrylate, allyl methacrylate, cyclohexyl acrylate, cyclohexyl methacrylate, phenyl acrylate, phenyl methacrylate, nonylphenyl acrylate, nonylphenyl methacrylate, benzyl acrylate, benzyl methacrylate, dicyclopentenyl acrylate, dicyclopentenyl methacrylate, bornyl acrylate, bornyl methacrylate, 1,3-butanediol diacrylate, 1,3-butanediol dimethacrylate, 1,4-butanediol diacrylate, 1,4-butanediol dimethacrylate, ethylene glycol diacrylate, ethylene glycol dimethacrylate, diethylene glycol diacrylate, diethylene glycol dimethacrylate, triethylene glycol diacrylate, triethylene glycol dimethacrylate, tetraethylene glycol diacrylate, tetraethylene glycol dimethacrylate, polyethylene glycol diacrylate, polyethylene glycol dimethacrylate, neopentyl glycol diacrylate, 1,6-hexanediol diacrylate, 1,6-hexanediol dimethacrylate, dipropylene glycol diacrylate, dipropylene glycol dimethacrylate, trimethylol propane triacrylate, trimethylol propane trimethacrylate, glycerol acrylate, glycerol methacrylate, styrene, methylstyrene, vinyl toluene, and hydroxyethylated orthophenylphenol acrylate. These may be used alone or as a mixture of two or more thereof.

Specific examples of the hydrophilic monomer include acrylic acid, methacrylic acid, maleic acid, and itaconic acid.

From the viewpoints of achieving good balance among gloss of a color image, prevention of bronzing, and storage stability of the ink composition and also of forming a color image with more excellent gloss, the copolymer resin of the above-mentioned hydrophobic monomer and the hydrophilic monomer is preferably at least any of a styrene-(meth)acrylic acid copolymer resin, a styrene-methylstyrene-(meth)acrylic acid copolymer resin, a styrene-maleic acid copolymer resin, a (meth)acrylic acid-(meth)acrylic acid ester copolymer resin, a styrene-(meth)acrylic acid-(meth)acrylic acid ester copolymer resin, and a hydroxyethylated orthophenylphenol acrylic acid ester-(meth)acrylic acid copolymer resin.

The copolymer resin may be a resin (styrene-acrylic acid resin) containing a polymer prepared by a reaction of styrene and acrylic acid or acrylic acid ester. Alternatively, the copolymer resin may be an acrylic acid-based water-soluble resin or a salt thereof, such as a sodium, potassium, ammonium, triethanolamine, triisopropanolamine, triethylamine, or diethanolamine salt.

The acid value of the copolymer resin is preferably 50 to 320 and more preferably 100 to 250 from the viewpoints of achieving good balance among gloss of a color image, prevention of bronzing, and storage stability of the ink composition and also of forming a color image with more excellent gloss.

The weight-average molecular weight (Mw) of the copolymer resin is preferably 2000 to 30000 and more preferably 2000 to 20000 from the viewpoints of achieving good balance among gloss of a color image, prevention of bronzing, and storage stability of the ink composition and also of forming a color image with more excellent gloss.

The glass transition temperature (Tg: measured in accordance with JIS K6900) of the copolymer resin is preferably 30° C. or more and more preferably 50 to 130° C. from the viewpoints of achieving good balance among gloss of a color image, prevention of bronzing, and storage stability of the ink composition and also of forming a color image with more excellent gloss.

The copolymer resin is adsorbed to the pigment or is free in a pigment dispersion and preferably has a maximum particle diameter of 0.3 μm or less and more preferably has an average particle diameter of 0.2 μm or less (more preferably 0.1 μm or less), from the viewpoints of achieving good balance among gloss of a color image, prevention of bronzing, and storage stability of the ink composition and also of forming a color image with more excellent gloss. Here, the average particle diameter is the average value of dispersion diameters (50% cumulative diameter) of particles actually formed by the pigment in the dispersion and can be measured with, for example, a Microtrac UPA (Microtrac Inc.).

The content of the copolymer resin is preferably 20 to 50 parts by mass and more preferably 20 to 40 parts by mass based on 100 parts by mass of the pigment, from the viewpoints of achieving good balance among gloss of a color image, prevention of bronzing, and storage stability of the ink composition and also of forming a color image with more excellent gloss.

In an aspect of the invention, an oxyethyl acrylate-based resin also can be used as the copolymer resin. The use of such a resin provides a reduction in the initial viscosity of ink, excellent storage stability at high temperature, and an excellent recovery property from clogging and is therefore more preferred.

The oxyethyl acrylate-based resin is not particularly limited as long as it has an oxyethyl acrylate skeleton, but is preferably a compound represented by the following Formula (I). Examples of the compound represented by Formula (I) include resins containing, in molar proportions of monomers, 45 to 55% of ortho-hydroxyethylated phenylphenol acrylate having CAS No. 72009-86-0, 20 to 30% of acrylic acid having CAS No. 79-10-7, and 20 to 30% of methacrylic acid having CAS No. 79-41-4. These may be used alone or as a mixture of two or more thereof. Furthermore, the monomer component ratios are not particularly limited, but are preferably 70 to 85% by mass of the ortho-hydroxyethylated phenylphenol acrylate having CAS No. 72009-86-0, 5 to 15% by mass of acrylic acid having CAS No. 79-10-7, and 10 to 20% by mass of methacrylic acid having CAS No. 79-41-4.

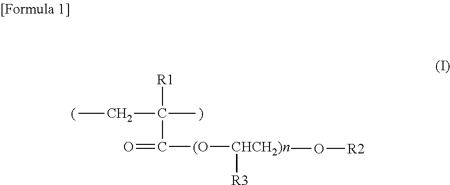

(R1 and/or R3 are a hydrogen atom or a methyl group, R2 is an alkyl group or an aryl group, and n is an integer of 1 or more.)

Preferred examples of the compound represented by Formula (I) include nonylphenoxypolyethylene glycol acrylate and polypropylene glycol #700 acrylate.

The content of the oxyethyl acrylate-based resin is preferably 10 to 40 parts by mass and more preferably 15 to 25 parts by mass based on 100 parts by mass of the pigment, from the viewpoints of achieving good balance between the initial viscosity of the ink composition and storage stability of the ink composition and also of inhibiting aggregation spots and forming a color image having an excellent burying property.

The total ratio of the resin components derived from monomers having hydroxyl groups selected from the group consisting of acrylic acids and methacrylic acids in the oxyethyl acrylate-based resin is preferably 30 to 70% and more preferably 40 to 60%, from the viewpoints of achieving good balance between the initial viscosity of the ink composition and the storage stability of the ink composition and also of the recovery property from clogging.

The number-average molecular weight (Mn) of the oxyethyl acrylate-based resin before cross-linking is preferably 4000 to 9000 and more preferably 5000 to 8000, from the viewpoints of achieving good balance between the initial viscosity of the ink composition and the storage stability of the ink composition. The Mn is measured by, for example, gel permeation chromatography (GPC).

The oxyethyl acrylate-based resin is adsorbed to the pigment or is free in a pigment dispersion, and the copolymer resin preferably has a maximum particle diameter of 0.3 μm or less and more preferably has an average particle diameter of 0.2 μm or less (more preferably 0.1 μm or less), from the viewpoints of achieving good balance among gloss of a color image, prevention of bronzing, and storage stability of the ink composition and also of forming a color image with more excellent gloss. Here, the average particle diameter is the average value of dispersion diameters (50% cumulative diameter) of particles actually formed by the pigment in the dispersion and can be measured with, for example, a Microtrac UPA (Microtrac Inc.).

The content of the oxyethyl acrylate-based resin is preferably 20 to 50 parts by mass and more preferably 20 to 40 parts by mass based on 100 parts by mass of the pigment, from the viewpoints of achieving good balance among gloss of a color image, prevention of bronzing, and storage stability of the ink composition and also of forming a color image with more excellent gloss.

Furthermore, in an aspect of the invention, by using a urethane-based resin as a fixative pigment dispersant, good balance among gloss of a color image, prevention of bronzing, and storage stability of the ink composition can be achieved, and a color image having more excellent gloss can be formed. The urethane-based resin is a resin containing a polymer obtained by a reaction of a diisocyanate compound and a diol compound and is, in an aspect of the invention, preferably a resin having a urethane bond and/or an amide bond and an acid group.

Examples of the diisocyanate compound include araliphatic diisocyanate compounds such as hexamethylene diisocyanate and 2,2,4-trimethyl hexamethylene diisocyanate; aromatic diisocyanate compounds such as toluoylene diisocyanate and phenylmethane diisocyanate; and modified derivatives thereof.

Examples of the diol compound include polyethers such as polyethylene glycol and polypropylene glycol; polyesters such as polyethylene adipate and polybutylene adipate; and polycarbonates.

The acid value of the urethane-based resin is preferably 10 to 300 and more preferably 20 to 100 from the viewpoints of achieving good balance among gloss of a color image, prevention of bronzing, and storage stability of the ink composition and also of forming a color image with more excellent gloss. Here, the acid value is the number of mg of KOH required to neutralize 1 g of the resin.

The weight-average molecular weight (Mw) of the urethane resin before cross-linking is preferably 100 to 200000 and more preferably 1000 to 50000 from the viewpoints of achieving good balance among gloss of a color image, prevention of bronzing, and storage stability of the ink composition and also of forming a color image with more excellent gloss. The Mw is measured by, for example, gel permeation chromatography (GPC).

The glass transition temperature (Tg: measured in accordance with JIS K6900) of the urethane resin is preferably −50 to 200° C. and more preferably −50 to 100° C. from the viewpoints of achieving good balance among gloss of a color image, prevention of bronzing, and storage stability of the ink composition and also of forming a color image with more excellent gloss.

The urethane-based resin preferably has a carboxyl group.

The content of the urethane-based resin is preferably 20 to 50 parts by mass and more preferably 20 to 40 parts by mass based on 100 parts by mass of the pigment from the viewpoints of achieving good balance among gloss of a color image, prevention of bronzing, and storage stability of the ink composition and also of forming a color image with more excellent gloss.

Furthermore, in an aspect of the invention, a fluorene-based resin can be used as a fixative pigment dispersant. The use such a resin causes a reduction in the initial viscosity of ink and provides excellent storage stability at high temperature and an excellent fixing property to fine coated paper or printing paper, and is therefore preferred.

In addition, the fluorene-based resin is not particularly limited as long as it has a fluorene skeleton, and, for example, can be obtained by copolymerizing the following monomer units:

cyclohexane, 5-isocyanate-1-(isocyanate methyl)-1,3,3-trimethyl-(CAS No. 4098-71-9); ethanol, 2,2′-[9H-fluoren-9-ylidenebis(4,1-phenyleneoxy)]bis-(CAS No. 117344-32-8); propionic acid, 3-hydroxy-2-(hydroxymethyl)-2-methyl-(CAS No. 4767-03-7); and ethanamine, N,N-diethyl-(CAS No. 121-44-8).

The monomer component ratios in the fluorene resin are not particularly limited as long as the resin has a fluorene skeleton, but are preferably 35 to 45% by mass of cyclohexane, 5-isocyanate-1-(isocyanate methyl)-1,3,3-trimethyl-(CAS No. 4098-71-9), 40 to 60% by mass of ethanol, 2,2′-[9H-fluoren-9-ylidenebis(4,1-phenyleneoxy)]bis-(CAS No. 117344-32-8), 5 to 15% by mass of propionic acid, 3-hydroxy-2-(hydroxymethyl)-2-methyl-(CAS No. 4767-03-7), and 5 to 15% by mass of ethanamine, N,N-diethyl-(CAS No. 121-44-8).

The number-average molecular weight (Mn) of the fluorene-based resin before cross-linking is preferably 2000 to 5000 and more preferably 3000 to 4000 from the viewpoints of achieving good balance between the initial viscosity of the ink composition and the storage stability of the ink composition. The Mn is measured by, for example, gel permeation chromatography (GPC).

The fluorene-based resin is adsorbed to the pigment or is free in a pigment dispersion, and the copolymer resin preferably has a maximum particle diameter of 0.3 μm or less and more preferably has an average particle diameter of 0.2 μm or less (further preferably 0.1 μm or less), from the viewpoints of achieving good balance among gloss of a color image, prevention of bronzing, and storage stability of the ink composition and also of forming a color image with more excellent gloss. Here, the average particle diameter is the average value of dispersion diameters (50% cumulative diameter) of particles actually formed by the pigment in the dispersion and can be measured with, for example, a Microtrac UPA (Microtrac Inc.).

The content of the fluorene-based resin is preferably 20 to 50 parts by mass and more preferably 20 to 40 parts by mass based on 100 parts by mass of the pigment from the viewpoints of achieving good balance among a color image-fixing property, prevention of bronzing, and storage stability of the ink composition and also of forming a color image with a more excellent fixing property.

The mass ratio of the copolymer resin to the fixative pigment dispersant (the former/the latter) is preferably 1/2 to 2/1 and is more preferably 1/1.5 to 1.5/1 from the viewpoints of achieving good balance among gloss of a color image, prevention of bronzing, and storage stability of the ink composition and also of forming a color image with more excellent gloss.

The mass ratio of the solid content of the pigment to the total solid content of the copolymer resin and the fixative pigment dispersant (the former/the latter) is preferably 100/40 to 100/100 from the viewpoints of achieving good balance among gloss of a color image, prevention of bronzing, and storage stability of the ink composition and also of forming a color image with more excellent gloss.

Furthermore, a surfactant may be used as the dispersant. Examples of the surfactant include anionic surfactants, such as fatty acid salts, higher alkyl dicarboxylates, higher alcohol sulfates, higher alkyl sulfonates, condensation products of higher fatty acids and amino acids, sulfosuccinates, naphthenates, liquid fatty oil sulfates, and alkylallyl sulfonates; cationic surfactants, such as fatty acid amine salts, quaternary ammonium salts, sulfonium salts, and phosphonium; and nonionic surfactants, such as polyoxyethylene alkyl ethers, polyoxyethylene alkyl esters, sorbitan alkyl esters, and polyoxyethylene sorbitan alkyl esters. It is needless to say that these surfactants also function as surfactants when they are added to ink compositions.

### Surfactant

The ink composition for ink jet recording according to an aspect of the invention may contain a surfactant. By using the surfactant, an image having excellent gloss can be formed on a recording medium having a surface coated by a resin for receiving ink and also on a recording medium of which gloss is highly important, such as photographic paper. Especially, even when a recording medium having an application layer for receiving oil-based ink as the receiving layer of the surface, such as fine coated paper or printing paper, is used, bleeding between colors can be prevented, and also whitening due to absorption spots of the ink, which occurs with an increase in the amount of adhering ink, can be prevented.

The surfactant used in an aspect of the invention is preferably a polyorganosiloxane-based surfactant, which can increase the permeability of ink by enhancing wettability to a recording medium surface, when a recording image is formed. When the polyorganosiloxane-based surfactant is used, since one type of the poor water-soluble both-end-type alkanediol and one type of the poly(alkylene glycol) described above are contained, the solubility of the surfactant in the ink is increased to inhibit occurrence of insoluble matters or the like, and thereby an ink composition excellent in discharge stability can be provided.

The polyorganosiloxane-based surfactant is not particularly limited, but is preferably one that provides an aqueous solution having a dynamic surface tension of 26 mN/m or less at 1 Hz when the aqueous solution is composed of 20% by mass of glycerin, 10% by mass of 1,2-hexanediol, 0.1% by mass of the polyorganosiloxane-based surfactant, and 69.9% by mass of water. The dynamic surface tension can be measured with, for example, a bubble pressure dynamic surface tensiometer, BP-2 (Kruss GmbH).

As the surfactant described above, those that are commercially available may be used. For example, Olfine PD-501 (Nissin Chemical Industry Co., Ltd.), Olfine PD-570 (Nissin Chemical Industry Co., Ltd.), BYK-347 (BYK-Chemie), or BYK-348 (BYK-Chemie) can be used.

Furthermore, the polyorganosiloxane-based surfactant more preferably contains one or more compounds represented by the following Formula (II):

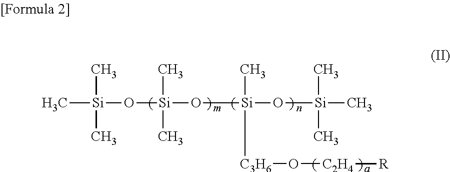

(in the formula, R represents a hydrogen atom or a methyl group, a represents an integer of 7 to 11, m represents an integer of 30 to 50, and n represents an integer of 3 to 5), or contains one or more compounds represented by Formula (II), wherein R represents a hydrogen atom or a methyl group, a represents an integer of 9 to 13, m represents an integer of 2 to 4, and n represents an integer of 1 or 2. Furthermore, the polyorganosiloxane-based surfactant more preferably contains one or more compounds represented by Formula (II), wherein R represents a hydrogen atom or a methyl group, a represents an integer of 6 to 18, m is 0, and n is 1; and more preferably contains one or more compounds represented by Formula (II), wherein R represents a hydrogen atom, a represents an integer of 2 to 5, m represents an integer of 20 to 40, and n represents an integer of 3 to 5. The use of such a specific polyorganosiloxane-based surfactant further reduces beading and bleeding of ink even in printing using fine coated paper or printing paper as the recording medium.

Beading of ink can be further reduced by using a compound represented by Formula (II) wherein R is a methyl group, and bleeding of ink can be also reduced by simultaneously using a compound represented by Formula (II) wherein R is a hydrogen atom.

In the compounds represented by Formula (II), by appropriately adjusting the blending ratio of the compound having R of a methyl group and the compound having R of a hydrogen atom, a high-quality image being free from bleeding and beading can be realized. In addition, the compounds are effective as adjusters when fluidity varies depending on the type of the pigment and the amount of the resin.

The amount of the surfactant contained in the ink composition according to an aspect of the invention is preferably 0.01 to 1.0% by mass and more preferably 0.05 to 0.50% by mass. In particular, when the surfactant is a compound in which R is a hydrogen atom, the amount thereof is preferably smaller than that of the surfactant that is a compound in which R is a methyl group, from the viewpoint of beading. When the surfactant in which R is a hydrogen atom is contained in an amount of 0.01 to 0.1% by mass, water repellency is provided, and bleeding can be prevented.

In addition, a Gemini-type surfactant can be suitably used as the surfactant used in an aspect of the invention. The use of the Gemini-type surfactant in combination with the poor water-soluble both-end-type alkanediol can uniformly disperse the poor water-soluble solvent, resulting in a reduction in the initial viscosity of ink. Therefore, the amounts of the color material, the clogging-preventing agent, and other additives contained in the ink composition can be increased, and, as a result, an image having excellent color development can be formed not only on plain paper but also on a recording medium having a porous surface on which a resin or particles for receiving ink is coated. Especially, even when a recording medium having an application layer for receiving oil-based ink as the receiving layer of the surface, such as fine coated paper or printing paper, is used, bleeding between colors can be prevented, and also color density spots caused by ink flow among dots, which occurs with an increase in the amount of adhering ink, can be prevented. The reason thereof is not clear, but it is thought that the fluidity of the colorant is lost because that the Gemini-type surfactant has excellent orientation to form extremely stable oil gel with the poor water-soluble solvent. Therefore, the addition of the Gemini-type surfactant is more effective when the amount of the poor water-soluble solvent is larger. Here, the term “Gemini-type surfactant” refers to a surfactant having a structure in which two surfactant molecules are connected to each other via a linker.

The Gemini-type surfactant is preferably a two-chain/three-hydrophilic group-type surfactant having a structure in which the hydrophilic group portions of a couple of one-chain type surfactants are connected to each other via a linker having a hydrophilic group. Furthermore, the hydrophilic group portions of the one-chain-type surfactants are preferably acidic amino acid residues, and the linker is preferably a basic amino acid. A specific example is a surfactant having a structure in which a couple of one-chain-type surfactants having glutamic acid or aspartic acid as the hydrophilic group portions are connected to each other via a linker such as arginine, lysine, or histidine. The Gemini-type surfactant used in an aspect of the invention is preferably a surfactant represented by the following Formula (III):

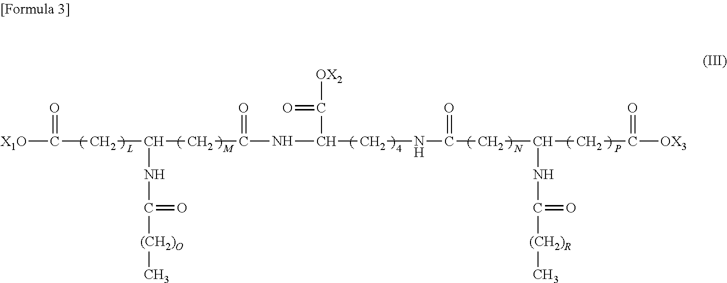

(in the Formula, X₁, X₂, and X₃ each independently represent a hydrogen atom or an alkali metal, but do not simultaneously represent hydrogen atoms or alkali metals; L and M each independently represent 0 or 2, but do not simultaneously represent 0 or 2; N and P each independently represent 0 or 2, but do not simultaneously represent 0 or 2; Q and R each represent an integer of 8 to 18).

In Formula (III), the alkali metal is preferably Na, and Q and R are each preferably around 10. Examples of such compounds include sodium salts of condensation products of N-lauroyl-L-glutamic acid and L-lysine. The compounds represented by Formula (III) may be those that are commercially available. For example, Pellicer L-30 (a product of Asahi Kasei Chemicals Corp.), which is an aqueous solution containing 30% of a sodium salt of a condensation product of N-lauroyl-L-glutamic acid and L-lysine, can be suitably used.

In an aspect of the invention, the use of the Gemini-type surfactant enhances permeability of ink by increasing the wettability of the ink to a recording medium surface when a recording image is formed. As a result, uneven aggregation of the ink is reduced even when the recording medium is fine coated paper or printing paper. In addition, since the ink composition according to an aspect of the invention contains the poor water-soluble both-end-type alkanediol, the solubility of the surfactant in the ink is improved to inhibit generation of insoluble matters or the like. Therefore, an ink composition having more excellent discharge stability can be obtained.

The amount of the Gemini-type surfactant contained in the ink composition according to an aspect of the invention is preferably 0.01 to 1.0% by mass and more preferably 0.05 to 0.50% by mass.

The ink composition according to a preferred aspect of the invention can contain both the polyorganosiloxane-based surfactant and the Gemini-type surfactant. The ink composition according to an aspect of the invention containing both these two types of surfactants can realize a high-quality image being free from bleeding and beading, and also these surfactants effectively function as adjusters when fluidity varies depending on the type of the pigment or the amount of the resin.

The ink composition according to an aspect of the invention may further contain another surfactant, for example, an acetylene glycol-based surfactant, an anionic surfactant, a nonionic surfactant, or an ampholytic surfactant.

Among them, examples of the acetylene glycol-based surfactant include 2,4,7,9-tetramethyl-5-decyne-4,7-diol, 3,6-dimethyl-4-octyne-3,6-diol, 3,5-dimethyl-1-hexyn-3-ol, and 2,4-dimethyl-5-hexyn-3-ol. The acetylene glycol-based surfactant may be those that are commercially available, and examples thereof include Olfine E1010, STG, and Y (trade names, manufactured by Nissin Chemical Industry Co., Ltd.), Surfynol 61, 104, 82, 465, 485, and TG (trade names, manufactured by Air Products and Chemicals Inc.).

### Water and Other Components

The ink composition for ink jet recording according to an aspect of the invention contains the above-described specific poor water-soluble both-end-type alkanediol, the specific poly(alkylene glycol), the surfactant, and other various additives and also water as a solvent. The water is preferably pure water or ultrapure water, such as ion-exchanged water, ultrafiltered water, reverse osmosis water, or distilled water. In particular, pure or ultrapure water subjected to sterilization with ultraviolet irradiation or addition of hydrogen peroxide can prevent occurrence of mold and bacteria over a long period of time and is therefore preferred.

Furthermore, the ink composition according to an aspect of the invention preferably contains a penetrant, in addition to the above-mentioned components.

As the penetrant, glycol ethers can be suitably used.

Specific examples of the glycol ethers include ethylene glycol monomethyl ether, ethylene glycol monoethyl ether, ethylene glycol mono-iso-propyl ether, ethylene glycol mono-n-butyl ether, ethylene glycol mono-iso-butyl ether, ethylene glycol mono-tert-butyl ether, ethylene glycol monomethyl ether acetate, diethylene glycol monomethyl ether, diethylene glycol monoethyl ether, diethylene glycol mono-n-propyl ether, diethylene glycol mono-iso-propyl ether, diethylene glycol mono-n-butyl ether, diethylene glycol mono-tert-butyl ether, triethylene glycol mono-n-butyl ether, propylene glycol monomethyl ether, propylene glycol monoethyl ether, propylene glycol mono-n-propyl ether, propylene glycol mono-iso-propyl ether, propylene glycol mono-n-butyl ether, propylene glycol mono-tert-butyl ether, dipropylene glycol monomethyl ether, dipropylene glycol monoethyl ether, dipropylene glycol mono-n-propyl ether, dipropylene glycol iso-propyl ether, dipropylene glycol mono-n-butyl ether, dipropylene glycol mono-tert-butyl ether, and 1-methyl-1-methoxybutanol. These may be used alone or as a mixture of two or more thereof.

Among the above-mentioned glycol ethers, preferred are alkyl ethers of polyols, and particularly preferred are ethylene glycol monoethyl ether, ethylene glycol mono-n-butyl ether, diethylene glycol monomethyl ether, diethylene glycol monoethyl ether, diethylene glycol mono-n-butyl ether, propylene glycol monomethyl ether, propylene glycol monoethyl ether, propylene glycol monobutyl ether, triethylene glycol monomethyl ether, triethylene glycol monoethyl ether, and triethylene glycol mono-n-butyl ether.

More preferred are triethylene glycol monomethyl ether and triethylene glycol mono-n-butyl ether.

The amount of the penetrant may be appropriately determined, but is preferably about 0.1 to 30% by mass and more preferably about 1 to 20% by mass.

Furthermore, the ink composition according to an aspect of the invention may preferably contain a recording medium-dissolving agent, in addition to the above-mentioned components.

As the recording medium-dissolving agent, pyrrolidones, such as N-methyl-2-pyrrolidone, pyrrolidone carbonate, and alkali metal salts thereof, can be suitably used. The amount of the recording medium-dissolving agent may be appropriately determined, but is preferably about 0.1 to 30% by mass and more preferably about 1 to 20% by mass.

The ink composition for ink jet recording according to an aspect of the invention preferably contains a wetting agent, for example, glycerin or its derivative, such as 3-(2-hydroxyethoxy)-1,2-propanediol (CAS No. 14641-24-8) or 3-(2-hydroxypropoxy)-1,2-propanediol. Glycerin and its derivative have functions of preventing ink, for example, in an ink jet nozzle from drying and solidifying and are therefore preferred from the viewpoint of a recovery property from clogging. In an aspect of the invention, since fluidity spots of ink can be effectively inhibited by the crystalline sugar alcohol, the ink composition can contain the wetting agent in an amount of from 0.1 to 8% by mass.

The ink composition according to an aspect of the invention can further contain a nozzle clogging-preventing agent, an antiseptic, an antioxidant, an electroconductivity adjuster, a pH adjuster, a viscosity modifier, a surface tension adjuster, and an oxygen absorber, for example.

Examples of the antiseptic/anti-fungal agents include sodium benzoate, sodium pentachlorophenol, sodium 2-pyridinethiol-1-oxide, sodium sorbate, sodium dehydroacetate, and 1,2-dibenzine thiazolin-3-one (Proxel CRL, Proxel BND, Proxel GXL, Proxel XL-2, and Proxel TN, available from ICI Co., Ltd.).

Furthermore, examples of the pH adjuster, a solubilization aid, or the antioxidant include amines, such as diethanolamine, triethanolamine, propanolamine, and morpholine and modified products thereof; inorganic salts, such as potassium hydroxide, sodium hydroxide, and lithium hydroxide; ammonium hydroxide; quaternary ammonium hydroxide (for example, tetramethyl ammonium); carbonates, such as potassium carbonate, sodium carbonate, and lithium carbonate; phosphates; ureas, such as N-methyl-2-pyrrolidone, urea, thiourea, and tetramethylurea; allophanates, such as allophanate and methyl allophanate; biurets, such as biuret, dimethyl biuret, and tetramethyl biuret; and L-ascorbic acid and salts thereof.

In addition, the ink composition according to an aspect of the invention may contain an antioxidant and an ultraviolet absorber, and examples thereof include Tinuvin 328, 900, 1130, 384, 292, 123, 144, 622, 770, and 292, Irgacor 252 and 153, and Irganox 1010, 1076, 1035, and MD 1024 (Chiba Specialty Chemicals Inc.) and oxides of lanthanide.

The ink composition according to an aspect of the invention can be produced by dispersing and mixing each component described above by a proper method. Preferably, first, a uniform pigment dispersion is prepared by mixing a pigment, a polymer dispersant, and water with a proper disperser (for example, a ball mill, a sand mill, an attritor, a roll mill, an agitator mill, a Henschel mixer, a colloid mill, an ultrasonic homogenizer, a jet mill, or an angmill). Then, added to the resulting pigment dispersion are a separately prepared resin (resin emulsion), water, a water-soluble organic solvent, a saccharide, a pH adjuster, an antiseptic, an anti-fungal agent, and other components. These are sufficiently dissolving to prepare an ink solution. After sufficient stirring, coarse particles and foreign materials, which cause clogging, are removed by filtration to obtain a target ink composition. The filtration may be preferably performed using a glass fiber filter. The glass fiber is preferably resin-impregnated glass fiber from the viewpoint of an electrostatic adsorption function. The pore size of the glass fiber filter is preferably 1 to 40 μm and more preferably 1 to 10 μm from the viewpoints of productivity and adsorptive removal of, for example, an electric charge-free resin. By sufficiently removing adsorption of an electric charge-free resin, etc., the discharge stability can be improved. An example of the filter is Ultipor GF Plus, a product of Nihon Pall Ltd.

### Ink Jet Recording Method

An ink jet recording method according to an aspect of the invention performs printing by discharging droplets of the ink composition described above and letting the droplets adhere to a recording medium. In the recording method according to an aspect of the invention, it is preferable to use fine coated paper (OK Ever Light Royal: a product of Oji Paper Co., Ltd.) or printing paper (OKT+: a product of Oji Paper Co., Ltd.) as a recording medium. Especially, a high-quality image being free from bleeding and beading can be realized on art paper, paper for high image quality used in print on demand (POD), and exclusive paper for laser printers, in particular, even in low-resolution printing. Examples of the paper for high image quality used in POD include Ricoh business coat gloss 100 (a product of Ricoh Company, Ltd.). Examples of the exclusive paper for laser printers include LPCCTA4 (a product of Seiko Epson Corp.). Examples of water resistant paper include Kareka (a product of Mitsubishi Kagaku Media Co., Ltd.) and LaserPeach (a product of Nisshinbo Postal Chemical Co., Ltd.).

### EXAMPLES

The invention will now be described in more detail below with reference to examples, but is not limited to those examples.

### Preparation of Ink Composition

Inks having compositions shown in Table 1 were prepared by mixing each component and filtering the mixture through a membrane filter with a pore size of 10 w. The numerical values shown in Table 1 represent contents (% by mass) in ink. The contents (% by mass) of resins are shown by their solid contents. Here, the oxyethylacrylate-based resin (oxyethyl resin) in Table 1 is a resin having a molecular weight of 6900 and containing a monomer having an oxyethyl acrylate structure shown by CAS No. 72009-86-0 in a monomer component ratio of about 75% by mass.

The fluorene-based resin (fluorene resin) is a resin having a molecular weight of 3300 and containing a monomer having a fluorene skeleton shown by CAS No. 117344-32-8 in a monomer component ratio of about 50% by mass.

In addition, the surfactant used is a polyorganosiloxane-based surfactant composed of a compound represented by Formula (II) wherein R is a methyl group, a is an integer of 6 to 18, m is 0, and n is 1, a compound represented by Formula (II) wherein R is a hydrogen atom, a is an integer of 7 to 11, m is an integer of 30 to 50, and n is an integer of 3 to 5, and a compound represented by Formula (II) wherein R is a methyl group, a is an integer of 9 to 13, m is an integer of 2 to 4, and n is an integer of 1 or 2. The polyorganosiloxane-based surfactant provided an aqueous solution having a dynamic surface tension of not higher than 26 mN/m at 1 Hz when the aqueous solution was composed of 20% by mass of glycerin, 10% by mass of 1,2-hexanediol, 0.1% by mass of the surfactant, and 69.9% by mass of water. Specifically, the dynamic surface tension was measured at 1 Hz (one bubble/sec) with a bubble pressure dynamic surface tensiometer, BP-2 (Kruss GmbH), to confirm that the dynamic surface tension of the aqueous solution at 1 Hz was 24.6 mN/m. The tripropylene glycol was one manufactured by Asahi Glass Co., Ltd., and the trehalose was Treha powder manufactured by Hayashibara Shoji, Inc.

The ink compositions in Examples 6 to 8 are those in which the polyorganosiloxane-based surfactant used in Examples 3 to 5 is changed to an acetylene glycol-based surfactant. Specifically, ink compositions and ink sets of Examples 6 to 8 were prepared as in Examples 3 to 5 except that Olfine E1010 (an alkylene oxide adduct of 2,4,7,9-tetramethyl-5-decyne-4,7-diol, an acetylene glycol-based surfactant manufactured by Nissin Chemical Industry Co., Ltd. was used. The acetylene glycol-based surfactant provided an aqueous solution having a dynamic surface tension of not lower than 27 mN/m at 1 Hz when the aqueous solution was composed of 20% by mass of glycerin, 10% by mass of 1,2-hexanediol, 0.1% by mass of the surfactant, and 69.9% by mass of water. Specifically, the dynamic surface tension was measured at 1 Hz (one bubble/sec) with a bubble pressure dynamic surface tensiometer, BP-2 (Kruss GmbH), to confirm that the dynamic surface tension of the aqueous solution at 1 Hz was 27.5 mN/m.

TABLE 1

| | | Example 1 | Example 2 | Example 3 | Example 4 | Example 5 |
|---|---|---|---|---|---|---|
| 2-Butyl-2-ethyl-1,3-propanediol | | 2 | 2 | 2 | 2 | 2 |
| Tripropylene glycol | | 2 | 10 | 2 | 10 | 6 |
| Trehalose | | 2 | 2 | 10 | 10 | 6 |
| Glycerin | | 5 | 5 | 5 | 5 | 5 |
| 1,2-Hexanediol | | 1 | 1 | 1 | 1 | 1 |
| Polyorganosiloxane-based surfactant | | 0.1 | 0.1 | 0.1 | 0.1 | 0.1 |
| Dispersion | Oxyethyl resin | 1.4 | 1.4 | 1.4 | 1.4 | 1.4 |
| | Fluorene resin | 1.4 | 1.4 | 1.4 | 1.4 | 1.4 |
| | Pigment | 7 | 7 | 7 | 7 | 7 |
| | Ultrapure water | 53.8 | 53.8 | 53.8 | 53.8 | 53.8 |

| | | | | | |
|---|---|---|---|---|---|
| Ultrapure water | 24.3 | 16.3 | 16.3 | 8.3 | 16.3 |
| Total | 100 | 100 | 100 | 100 | 100 |
| Recovery property from clogging | B | AA | B | AA | A |
| in high-temperature and | | | | | |
| low-humidity open system | | | | | |
| Recovery property from clogging | B | B | AA | AA | A |
| in high-temperature and | | | | | |
| ordinary-humidity close system | | | | | |
| Curling | B | B | A | A | A |
| Beading | B | B | A | A | A |
| Bleeding | A | A | A | A | A |

| | | Example 6 | Example 7 | Example 8 |
|---|---|---|---|---|
| 2-Butyl-2-ethyl-1,3-propanediol | | 2 | 2 | 2 |
| Tripropylene glycol | | 2 | 10 | 6 |
| Trehalose | | 10 | 10 | 6 |
| HS500 | | 0 | 0 | 0 |
| HS60 | | 0 | 0 | 0 |
| HS20 | | 0 | 0 | 0 |
| Glycerin | | 5 | 5 | 5 |
| 1,2-Hexanediol | | 1 | 1 | 1 |
| Acetylene glycol-based surfactant | | 0.1 | 0.1 | 0.1 |
| Dispersion | Oxyethyl resin | 1.4 | 1.4 | 1.4 |
| | Fluorene resin | 1.4 | 1.4 | 1.4 |
| | Pigment | 7 | 7 | 7 |
| | Ultrapure water | 53.8 | 53.8 | 53.8 |

| | | | |
|---|---|---|---|
| Ultrapure water | 16.3 | 8.3 | 16.3 |
| Total | 100 | 100 | 100 |
| Recovery property from clogging | B | AA | A |
| in high-temperature and | | | |
| low-humidity open system | | | |
| Recovery property from clogging | AA | AA | A |
| in high-temperature and | | | |
| ordinary-humidity close system | | | |
| Curling | A | A | A |
| Beading | C | C | C |
| Bleeding | C | C | C |

| | | Comparative | Comparative | Comparative | Comparative | Comparative |
|---|---|---|---|---|---|---|
| | | Example 1 | Example 2 | Example 3 | Example 4 | Example 5 |
| 2-Butyl-2-ethyl-1,3-propanediol | | 2 | 2 | 2 | 2 | 2 |
| Tripropylene glycol | | 6 | 6 | 6 | 0 | 6 |
| Trehalose | | 0 | 0 | 0 | 6 | 0 |
| HS500 | | 6 | 0 | 0 | 0 | 0 |
| HS60 | | 0 | 6 | 0 | 0 | 0 |
| HS20 | | 0 | 0 | 6 | 0 | 0 |
| Glycerin | | 5 | 5 | 5 | 5 | 5 |
| 1,2-Hexanediol | | 1 | 1 | 1 | 1 | 1 |
| Polyorganosiloxane-based surfactant | | 0.1 | 0.1 | 0.1 | 0.1 | 0.1 |
| Dispersion | Oxyethyl resin | 1.4 | 1.4 | 1.4 | 1.4 | 1.4 |
| | Fluorene resin | 1.4 | 1.4 | 1.4 | 1.4 | 1.4 |
| | Pigment | 7 | 7 | 7 | 7 | 7 |
| | Ultrapure water | 53.8 | 53.8 | 53.8 | 53.8 | 53.8 |

| | | | | | |
|---|---|---|---|---|---|
| Ultrapure water | 16.3 | 16.3 | 16.3 | 22.3 | 22.3 |
| Total | 100 | 100 | 100 | 100 | 100 |
| Recovery property from clogging | B | B | B | C | B |
| in high-temperature and | | | | | |
| low-humidity open system | | | | | |
| Recovery property from clogging | C | C | B | A | C |
| in high-temperature and | | | | | |
| ordinary-humidity close system | | | | | |
| Curling | C | C | C | C | C |
| Beading | C | C | C | A | B |
| Bleeding | B | B | B | A | A |

* In the following ink sets, “Y” contains C.I. pigment yellow 74 as the pigment, “M” contains C.I. pigment violet 19 as the pigment, “C” contains C.I. pigment blue 15:3 as the pigment, and “K” contains C.I. pigment black 7 as the pigment.

### Evaluation

Recovery Property from Clogging in High-Temperature and Low-Humidity Open System

An ink set including Y, M, C, and K inks prepared above was mounted on an ink cartridge of an ink jet printer (PX-G930, a product of Seiko Epson Corp.) and set to the printer. Then, the head of the printer was filled with the ink using a printer driver to confirm that usual recording was possible. The carriage was transferred to the ink cartridge exchanging position, followed by unplugging. After dismounting of the ink cartridge from the printer, the head was detached. The head from which the ink cartridge and the head cap were removed was left to stand for three days under an environment of 50° C./15% humidity.

After the leaving, the head was set to the carriage again, and the ink cartridge, which was left to stand under an environment of ordinary temperature and ordinary humidity, was mounted on the printer. Then, cleaning operation was repeated until all nozzles discharged ink in an equal manner to that of the initial stage. The easiness of recovery was evaluated in accordance with the following criteria. In the evaluation, when clogging was not eliminated even by repeating the cleaning operation sixteen times, the energization was stopped by turning off the switches according to the usual usage procedure, followed by unplugging. The printer was left under an environment of ordinary-temperature and ordinary-humidity for one day, and then the cleaning operation was performed.

AA: recovered from clogging by repeating the cleaning operation six times;

A: recovered from clogging by repeating the cleaning operation twelve times;

B: recovered from clogging by repeating the cleaning operation sixteen times; and

C: not recovered from clogging by repeating the cleaning operation sixteen times, but recovered from the clogging by repeating the cleaning operation six times after being left.

### The Results are Shown in Table 1.

Recovery Property from Clogging in High-Temperature and Ordinary-Humidity Close System

An ink set including Y, M, C, and K inks prepared above was mounted on an ink cartridge of an ink jet printer (PX-G930, a product of Seiko Epson Corp.) and set to the printer. Then, the head of the printer was filled with the ink using a printer driver to confirm that usual recording was possible. Then, the energization was stopped by turning off the switches according to the usual usage procedure, followed by unplugging. The printer was left to stand for three days under an environment of 40° C./45% humidity.

After the leaving, the printer was energized, and cleaning operation was repeated until all nozzles discharged ink in an equal manner to that of the initial stage. The easiness of recovery was evaluated in accordance with the following criteria:

AA: recovered from clogging by repeating the cleaning operation six times;

A: recovered from clogging by repeating the cleaning operation twelve times;

B: recovered from clogging by repeating the cleaning operation sixteen times; and

C: not recovered from clogging by repeating the cleaning operation sixteen times.

The results are shown in Table 1. It was confirmed from Table 1 that the ink composition containing trehalose was excellent in recovery property from clogging in the high-temperature and low-humidity open system. HS20 is a nonreducing sugar containing a large amount of tetrasaccharides, HS60 is a nonreducing sugar containing a large amount of disaccharides, and HS500 is a nonreducing sugar containing a large amount of monosaccharides.

### Evaluation of Curling

An ink set including Y, M, C, and K inks prepared above was mounted on an ink cartridge of an ink jet printer (PX-G930, a product of Seiko Epson Corp.) so as to perform recording at 720 dpi in the main scanning (head driving) direction and at 360 dpi in the sub-scanning (recording medium transporting) direction. Then, the voltage applied to a piezo element of the printer head was adjusted such that the dot weight at the time of landing was about 3 ng, and a solid image of 720×720 dpi was recorded at 720×360 dpi per one driving on OKT+ (manufactured by Oji Paper Co., Ltd.) having a paper weight of about 73.3 g/m² and on Xerox P (manufactured by Fuji Xerox Co., Ltd.) having a paper weight of about 60 g/m², with a margin of about 6 mm on the periphery. The recording was conducted under an environment of ordinary temperature and ordinary humidity (25° C., 45% humidity). On this occasion, the amount of adhering ink of a monochromatic color at 100% duty was about 1.6 mg/inch². The resulting recorded matters were placed on a flat table with the recorded surfaces upward and were left to stand for three days under an environment of ordinary temperature and ordinary humidity (25° C., 45% humidity). The recorded images were monochromatic images.

The resulting images were evaluated in accordance with the following criteria. For each of the two types of the recording paper, the distances from the table to the four rolled corners of each recording paper were measured, and the average thereof was calculated to obtain the average (OKT+) in the OKT+ and the average (XeroxP) in the Xerox P. The average (ALL) of the average (OKT+) and the average (XeroxP) of the two types of recording paper was further calculated and was used as an index of the evaluation.

A: the average (ALL) is not larger than 10 mm;

B: the average (ALL) is larger than 10 mm and not larger than 20 mm; and

C: the average (ALL) is larger than 20 mm.

The results were as shown in Table 1.

### Evaluation of Image Quality: Ink Beading

An ink set including Y, M, C, and K inks prepared above was mounted on an ink cartridge of an ink jet printer (PX-G930, a product of Seiko Epson Corp.) so as to perform recording at 720 dpi in the main scanning (head driving) direction and at 360 dpi in the sub-scanning (recording medium transporting) direction. Then, the voltage applied to a piezo element of the printer head was adjusted such that the dot weight at the time of landing was about 3 ng, and a solid image of 1440×1440 dpi was recorded at 720×360 dpi per one driving on OKT+ (manufactured by Oji Paper Co., Ltd.) having a paper weight of about 128 g/m². The recording was conducted under an environment of ordinary temperature and ordinary humidity (25° C., 45% humidity). On this occasion, the amount of adhering ink of a monochromatic image at 100% duty was about 6.2 mg/inch².

The distance between the recording sheet and the recording head was 1 mm.

The recorded image was an image of a secondary color obtained by mixing monochromatic colors of the same duty.

The resulting images were evaluated in accordance with the following criteria:

A: reproduced without beading up to a secondary color at 80% duty of each monochromatic color at 40% duty;

B: reproduced without beading up to a secondary color at 70% duty of each monochromatic color at 35% duty; and

C: reproduced without beading up to a secondary color at 60% duty of each monochromatic color at 30% duty. The results are shown in Table 1.

### Evaluation of Image Quality: Ink Bleeding

An ink set including Y, M, C, and K inks prepared above was mounted on an ink cartridge of an ink jet printer (PX-G930, a product of Seiko Epson Corp.) so as to perform recording at 720 dpi in the main scanning (head driving) direction and at 360 dpi in the sub-scanning (recording medium transporting) direction. Then, the voltage applied to a piezo element of the printer head was adjusted such that the dot weight at the time of landing was about 3 ng, and an image of 1440×1440 dpi was recorded at 720×360 dpi per one driving on OKT+(manufactured by Oji Paper Co., Ltd.) having a paper weight of about 128 g/m². The recording was conducted under an environment of ordinary temperature and ordinary humidity (25° C., 45% humidity). On this occasion, the amount of adhering ink of a monochromatic color at 100% duty was about 6.2 mg/inch².

The distance between the recording sheet and the recording head was 1 mm.

The recorded image was an image in which 2 to 8 pixel lines of a primary color at 40% duty were in contact with a secondary color at 80% duty of each color at 40% duty.

The resulting images were evaluated in accordance with the following criteria:

A: reproduced 6/720 inch line without bleeding, but not reproduced 4/720 inch line due to bleeding;

B: reproduced 8/720 inch line without bleeding, but not reproduced 6/720 inch line due to bleeding; and

C: not reproduced 10/720 inch line due to bleeding. The results are shown in Table 1.

Ink compositions and ink sets of Examples 9 to 11 were prepared as in Examples 6 to 8, respectively, except that the acetylene-based surfactant used in Examples 6 to 8 was changed to Surfynol 104 (2,4,7,9-tetramethyl-5-decyne-4,7-diol), an acetylene glycol-based surfactant manufactured by Air Products and Chemicals Inc. (USA). The acetylene glycol-based surfactant provided an aqueous solution having a dynamic surface tension of not lower than 27 mN/m at 1 Hz when the aqueous solution was composed of 20% by mass of glycerin, 10% by mass of 1,2-hexanediol, 0.1% by mass of the surfactant, and 69.9% by mass of water. Specifically, the dynamic surface tension was measured at 1 Hz (one bubble/sec) with a bubble pressure dynamic surface tensiometer, BP-2 (Kruss GmbH), to confirm that the dynamic surface tension of the aqueous solution at 1 Hz was 27.8 mN/m. These were similarly evaluated to obtain the same evaluation results as in Examples 6 to 8.

Ink compositions and ink sets of Examples 12 to 22 and Comparative Examples 6 to 10 were prepared as in Examples 1 to 11 and Comparative Examples 1 to 5, respectively, except that 1,2-hexanediol was changed to 1,6-hexanediol. These were similarly evaluated to confirm that the results when 1,6-hexanediol was used were the same as those when 1,2-hexanediol was used.

Ink compositions and ink sets of Examples 23 to 33 and Comparative Examples 11 to 15 were prepared as in Examples 1 to 11 and Comparative Examples 1 to 5, respectively, except that 1,2-hexanediol was changed to 3-methyl-1,5-pentanediol. These were similarly evaluated to confirm that the evaluation results when 3-methyl-1,5-pentanediol was used were the same as those when 1,2-hexanediol was used.

Ink compositions and ink sets of Examples 34 to 66 and Comparative Examples 16 to 30 were prepared as in Examples 1 to 33 and Comparative Examples 1 to 15, respectively, except that the amount of glycerin was decreased to 0% by mass and that the amount of ultrapure water was increased by the amount of the glycerin. These were similarly evaluated to confirm that the evaluation results of the evaluation items other than those of the recovery property from clogging in the high-temperature and low-humidity open system were the same regardless of the amount of glycerin. The levels of recovery property from clogging in the high-temperature and low-humidity open system were decreased by one level, excepting the evaluation results in Comparative Examples 19, 24, and 29. In Comparative Examples 19, 24, and 29, the evaluation results, “C”, of the high-temperature and low-humidity open system were maintained.

What is claimed is:

1. An ink composition for ink jet recording, comprising at least:
a colorant;
water;
a poor water-soluble both-end-type alkanediol;
a crystalline sugar alcohol that is solid at 20° C.; and
a poly(alkylene glycol),
wherein the poor water-soluble both-end-type alkanediol includes one or two alkyl substituents on its main chain having two hydroxyl groups.

2. The ink composition according to claim 1, wherein the crystalline sugar alcohol is one or more selected from the group consisting of trehalose, isotrehalose, neotrehalose, and sucrose.

3. The ink composition according to claim 1, further comprising a water-soluble alkanediol,
wherein the water-soluble alkanediol is a both-end-type or one-end-type alkanediol having three or more carbon atoms.

4. The ink composition according to claim 1, wherein the poor water-soluble both-end-type alkanediol has seven or more carbon atoms.

5. The ink composition according to claim 1, wherein the poly(alkylene glycol) is one or more selected from the group consisting of ethylene glycol, diethylene glycol, triethylene glycol, propylene glycol, dipropylene glycol, and tripropylene glycol.

6. The ink composition according to claim 1, wherein the poly(alkylene glycol) is diol-type poly(propylene glycol).

7. The ink composition according to claim 6, wherein the diol-type poly(propylene glycol) is tripropylene glycol.

8. The ink composition according to claim 1, wherein the ratio of the content of the poor water-soluble both-end-type alkanediol to the content of the crystalline sugar alcohol is from 1:1 to 1:5.

9. The ink composition according to claim 1, wherein the ratio of the sum of contents of the poly(alkylene glycol) and the crystalline sugar alcohol to the content of the poor water-soluble both-end-type alkanediol is from 2:1 to 20:1.

10. The ink composition according to claim 1, wherein the sum of the content of the poor water-soluble both-end-type alkanediol and the content of the poly(alkylene glycol) or the crystalline sugar alcohol is 24% by mass or less based on the amount of the ink composition.

11. The ink composition according to claim 3, wherein the sum of the content of the water-soluble alkanediol and the content of the poly(alkylene glycol) or the crystalline sugar alcohol is 24% by mass or less based on the amount of the ink composition.

12. The ink composition according to claim 3, wherein the sum of the content of the poly(alkylene glycol) or the crystalline sugar alcohol, the content of the water-soluble alkanediol, and the content of the poor water-soluble both-end-type alkanediol is 28% by mass or less based on the amount of the ink composition.

13. The ink composition according to claim 1, wherein the content of the crystalline sugar alcohol is 2.0 to 10.0% by mass based on the amount of the ink composition.

14. The ink composition according to claim 1, wherein the poor water-soluble both-end-type alkanediol is one or more selected from the group consisting of 2-butyl-2-methyl-1,3-propanediol, 2-butyl-2-ethyl-1,3-propanediol, 2,2-dibutyl-1,3-propanediol, and 2,2-diisobutyl-1,3-propanediol.

15. The ink composition according to claim 1, further comprising a surfactant.

16. The ink composition according to claim 15, wherein the surfactant is a polyorganosiloxane-based surfactant or a Gemini-type surfactant.

17. The ink composition according to claim 16, wherein the polyorganosiloxane-based surfactant provides an aqueous solution having a dynamic surface tension of 26 mN/m or less at 1 Hz when the aqueous solution is composed of 20% by mass of glycerin, 10% by mass of 1,2-hexanediol, 0.1% by mass of the polyorganosiloxane-based surfactant, and 69.9% by mass of water.
